(19) United States
(12) Patent Application Publication
(10) Pub. No.: US 2005/0147946 A1
(43) Pub. Date: Jul. 7, 2005

(54) Automatic object generation and user interface identification

(76) Inventors: Shankar Ramamurthy, Herndon, VA (US); Ravi Ramamurthy, Bangalore (IN); Chandrashekar Ramamurthy, Bangalore (IN)

Correspondence Address: SCHIFF HARDIN, LLP;PATENT DEPARTMENT, 6600 SEARS TOWER, CHICAGO, IL, 60606-6473, US

(21) Appl. No.: 10/749,423

(22) Filed: Dec. 31, 2003

(51) Int. Cl. G06N 5/02; G06F 17/00; G06N 5/04; G09B 19/00

(52) U.S. Cl. 434/118; 706/46; 434/236

(57) ABSTRACT

A method and system for generating knowledge objects from captured process data and identification of user interface information includes knowledge object logic, knowledge object content, knowledge object presentation and knowledge object deployment. After capture of process data, analysis of the process is performed. The context of the process is defined, the best practices are identified, and process documentation and training on the process is performed through an interface. Once these elements are prepared as templates, they are deployed to a user to permit even an untrained user to perform the process as if the user were an expert.

### BACKGROUND OF THE INVENTION

1. Field of the Invention

The present invention relates generally to a method and apparatus for generating software objects and providing a user interface identification, and in particular to a system and method for increasing efficiency in processes, such as business processes.

2. Description of the Related Art

In business, people do their work through processes, performing the work processes step-by-step. A person may take twenty steps to complete a daily task at work. It would be an improvement if unnecessary steps were eliminated. Examples of some tasks a person in a business might perform are preparation and mailing of invoices, or collecting information from a file, making related telephone calls and sending a letter on the findings.

Users of business software develop procedures and habits for performing the business processes they are to perform as part of their job. These procedures and habits are often not particularly efficient and can include unnecessary steps, repetitive or inefficient practices, business tools and software that are not tailored to the tasks at hand, etc. They also require specific knowledge and training to make decisions and perform these processes effectively, that is rarely provided to a user. Previously, elimination of the laborious practices required interviews of the persons in the business, task analysis and observations, video-recordings of the task, note taking by an observer and review of the notes, quality assurance (QA) checking, reviews of the procedures by a committee, etc. In other words, a substantial manpower commitment, of a scarce and expensive skill variety, is required to examine the practices in an effort to reduce the waste and guarantee effectiveness of process performance. Increasing efficiency and effectiveness without requiring such procedures would make it affordable for organizations to attempt this more frequently.

Organizations have invested lot of money on current Information Technology (IT) infrastructure and many are faced with the problem of how to extract unrealized values from these large enterprise applications (i.e. software). Business process have become complex and are dependent on large, complex and many times enterprise wide applications. It is difficult and expensive to analyze and assess broken or inefficient business processes. Changes in the software applications lead to long cycles of development and implementation in order to make the changes necessary to affect the process changes.

An example of an enterprise systems which monitors, benchmarks and finds usage of hardware resources is Tivoli, but no tool is available to find out the usage of the costliest business resource—the human resource.

### SUMMARY OF THE INVENTION

The present invention provides automatic object generation and user interface identification for, in the various embodiments, generating documents, providing training, generating just-in-time guides and assistants or simplified and work automation wizards require specific technical skill and consumes significant time and efforts. As business processes or underlying technology or applications change the efforts, time and costs of making and managing these changes are extremely high. All the content generated also can be context aware.

### BRIEF DESCRIPTION OF THE DRAWINGS

FIG. 1 is a block diagram showing the questions of a user in performing a task placed into context;

FIG. 2 is a block diagram showing the knowledge provisioning according to the principles of the present invention;

FIG. 3 is a functional block diagram showing the architecture of the present system;

FIG. 4 is a functional block diagram showing the repository management system;

FIG. 5 is a functional block diagram showing template editors and a template repository;

FIG. 6 is a functional block diagram of a knowledge management system;

FIG. 7 is a schematic diagram of a software developer's kit used to deploy the present system; and

FIG. 8 is a block showing the use of the present method and system.

### DETAILED DESCRIPTION OF THE PREFERRED EMBODIMENTS

This invention utilizes captured data from user work sessions. A method and apparatus for such capture is disclosed in co-pending U.S. patent application entitled, “REMOTE PROCESS CAPTURE, IDENTIFICATION, CATALOGING AND MODELING”, assigned to the same assignee as the present application and identified as attorney docket no. P03,0262, which application is incorporated herein by reference.

The automatic object generation and user interface identification enables automatic generation of business process documentation, simulation, animation, tests, guides, assistants and the like, reducing the costs, time and efforts to a small fraction. This is based upon the following five components of the technology.

a) An articulation component of the technology articulates human interactions with software interfaces into unique sentences based upon sentence generation rules applied on XML (extensible Mark-up Language) process scripts. These sentences can be consistently generated in any language (including Unicode) and style based upon requirement.

b) An assimilation component of the technology automatically assembles the sentences, with relevant technology based images, voice, and video and external content in XML standard forms or other industry leading standard forms into a desired output form. The output forms can be programmatically predetermined in templates based upon industry standard XSLT (Extensible Stylesheet Language Transformations) style sheets, or XML based content management systems, or other industry leading forms, making possible dynamic fusion of external and content. The content can be presented in any or all forms such as html (Hyper Text Markup Language), wml (Wireless Markup Language), Word (Microsoft Word), pdf (Portable Document Format), avi (Advanced Visual Interface), flash, etc.

c) An interface simplification component automatically generates a self evident user interface blending live-in-the application guide and wizards.

d) A content presentation environment enables experts to import, export, change and edit content and self evident user interface, manually or automatically through templates.

e) An intelligent dialog technology is provided that is aware of the current user context and presents the user with a list of intelligent choices based on where the user is. Based on his context, the intelligent dialog technology presents the content and knowledge objects automatically. A key mathematical limitation in self evident user interfaces have been generally overlooked, leading to expectations and attempts at simplification of user interfaces destined to fail. The mathematical limitation of complexity can be summarized in two conjectures as follows:
a. No user interface can be simultaneously simple and comprehensive. A user interface can be simple and self evident only if the anticipated uses are limited to a number of small order and can be reduced to an unambiguous and simple process flow. A user interface that has a high order of potential tasks to be accomplished cannot be reduced to a self evident interface.
b. A complex interface can be made self evident only by fusing specifics of a user's goal with resources and information needed to accomplish the user goal.

This technology fuses knowledge into business processes as a consequence of three unique capabilities.

a) Defining unique context links and goals for a user process model (typically done by business experts)

b) Linking information and resources needed to achieve a goal given a context (typically done by business experts)

c) Dynamic ascertainment of context and a user goal through dynamic tracking of user interaction with their applications.

Information or resources made available based on user need transforms a passive set of self-evident interfaces into dynamically assembled and simplified real time knowledge enriched interface.

For a discussion of capture technology including capture of XML scripts from a user's computer or workstation using listeners and footprints to determine the context of the captured information, see the co-pending U.S. patent application entitled, “REMOTE PROCESS CAPTURE, IDENTIFICATION, CATALOGING AND MODELING”, attorney docket no. P03,0262, which application is incorporated herein by reference.

The present technology creates the following based on the captured processes: context maps, documentation, e-learning content, automatic user interface for guidance through the process, and automatic user interface for automatic playback of the process.

Most of the objects above are automatically generated based on the captured processes.

The final content and context maps are generated and can be used through browsers (such as Internet Explorer and Netscape), handheld devices, flash devices.

In current products and technologies it is cumbersome to produce the above material, once the process is defined. Any changes in the enterprise application or the process, results in complete rework of the content.

Using the automatic generation and user identification technology the following unique advantages are obtained in the various embodiments:

Since much of the content and user interface is automatically generated, time to develop content is reduced by 90%.

Any changes in processes or enterprise applications results in change in the process file. It is easy to modify the process files. Change management results in content being generated with more than 80% efficiency.

All the content are automatically made context aware and serve as performance support tools. While the user is performing takes, the list of content is bought up automatically based on the context of the user. In other tools, this has to be hand coded but using the present technology this capability is automatically generated.

User interfaces for guidance and playback are automatically generated. This allows users to get support while interacting with the live enterprise application. Such capabilities are not available in any other application. The benefits of this are a reduction in error rate for performing the process by over 75% and an 80% improvement in completion of the process, a reduction in gap between beginners and proficient users and reduced training requirements.

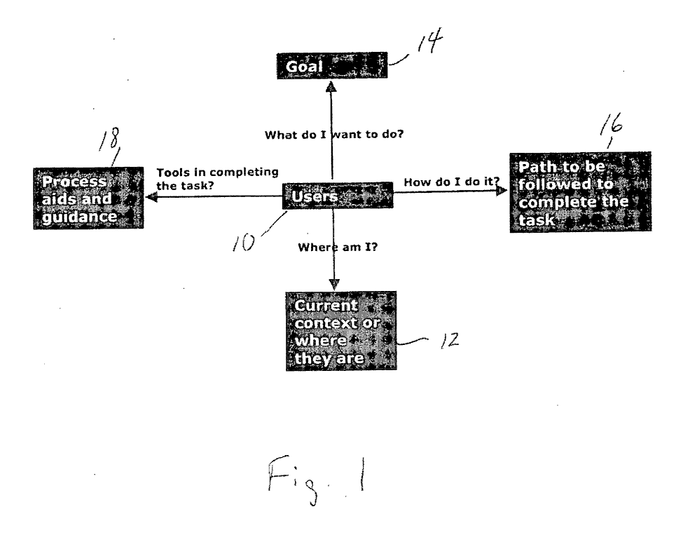

FIG. 1 shows users 10 posing questions relating to the performance of a task. These questions put the task into context. The first step is in establishing the current context of the user or answering the question “Where am I?,” as indicated at 12. The methods for determining the context may be simple or may be complex. A simple method to determine the context is to find out what the user did last or to look at the last visited screen or control. A more complex method of determining the context is to trace the history of the user and expunge noise actions from the history. Removing noise itself is a challenge since to do so requires the answer to the questions, “What is noise, and how do we determine noise?”

Once the context 12 of the task is established, the knowledge provisioning system has to determine the goal 14 of the user 10. In many cases, the user 10 may not be very clear on what the goal is or may have a only a fuzzy, or vague, idea of what the user is to do. One of the challenges is establishing a very clear goal that the system can understand. A current context is a must for determining the goal of the user. Contexts are mapped to goals, so given the context it may be possible to map out all the possible goals. The mapping process may yield more than one goal. In such a case, fuzzy logic methods or case-based reasoning and an intelligent dialog technology is used to establish the goal 14 clearly.

Once the context 12 and the goals 14 are established, the next step is to determine the path 16 that is to be followed to complete the task. The path 16 is a set of steps connecting the current context 12 to the goal 14.

Process aids and guidance 18 are required to aid the user 10 and present the user with the necessary tools, process knowledge, business policies, training and references to help the user in following the path 16.

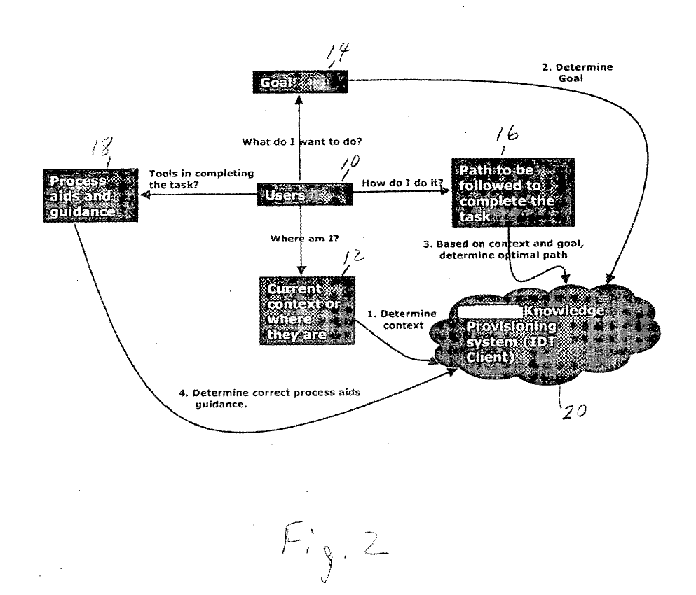

In FIG. 2 is an illustration of the present knowledge provisioning system 20. The knowledge provisioning system 20 is an IDT (Internet Data Transfer) client. The system's ability to “understand” the context 12 is used to provide disparately available content and information in a highly compact, intelligent and usable form for every user, or employee of the organization. The present system 20 understands the context 12 in two forms: a) the machine context of what the user 10 is doing with the ESA (Enterprise Systems Architecture), b) goal 14 context, or what business process the user needs to perform, c) optimal path to achieve the goal 14, and d) correct process aids and process guidance. The present system 20 can therefore provide highly relevant and just-in-time information based on context 12, making it a knowledge provisioning system, providing just the necessary set of information needed by the user 10, that otherwise was not accessible to the user except by knowledge of the process.

Put another way, the present knowledge provisioning system 20: first, determines the context 12; second, determines the goal 14; third, based on the context 12 and the goal 14, determines the optimal path 16; and fourth, determines the correct process aids and guidance 18.

The knowledge embedded into the business process is provided by the present system's ability to stream its captured process scripts into an ESA, or to poll system and application events, is used provide a business user with a knowledge embedded single unified interface. This helps the user 10 conduct a business process with the competence of a technical expert in using ESA and different domain experts in knowledgeably performing the processes. The present system can further minimize the interaction for the user 10 of the ESA, by automating repeatable or redundant activities. A rule engine of a preferred embodiment executes the rules and conditions for providing just the right process, the right interface and information to provide to the user 10, thereby mass customizing business processes for business users.

In one embodiment, a powerful combination of content, just-in-time knowledge provisioning and processes embedded with knowledge; called Business Knowledge Objects (BKO) is created. The knowledge object is a dynamic assembly of content, based upon the user context and the rule engine it triggers for extracting the relevant contact and performing the relevant actions of the process.

The knowledge provisioning technology also allows end users to add knowledge from e-mails, Microsoft Word documents or other sources. These are automatically put through a review system and finally are published. Once published all this information is available to the end users 10.

The overall development process and the architecture of the present system provide that at the core is a robust easy to use capture technology that records the operational aspect of any business process within and across disparate business applications as reusable XML scripts. This approach eliminates the laborious practices of the past—interviews, task analysis, video-recordings, note taking, Q&A, committee reviews, etc. By recording the user as the user performs the task, the accuracy of the process itself is never in doubt—if the user's interactions accomplish what the user has set out to do the user can be sure that what has been captured is an accurate step-by-step recording of the process. The whole interaction is now available in XML and represents a complete and detailed transcript of the process. The analogy is a relational database of financial data- extraction or reconstruction can always be performed for financial transactions, multi-dimensional analysis created and the information presented in a myriad ways as long as the data is resident in the database.

The XML record of the business process has the same potential—it can be transformed into many different kinds of output. One can document the process, by applying language style sheets and templates and present it in a variety of formats and languages. One can export it as a Microsoft PowerPoint slide show or produce animations with appropriate captions and voice annotations or, create a web-based training environment, embedded assistants or highly context-sensitive performance support. The diagram of FIG. 2 represents the principle of capture once and render many times.

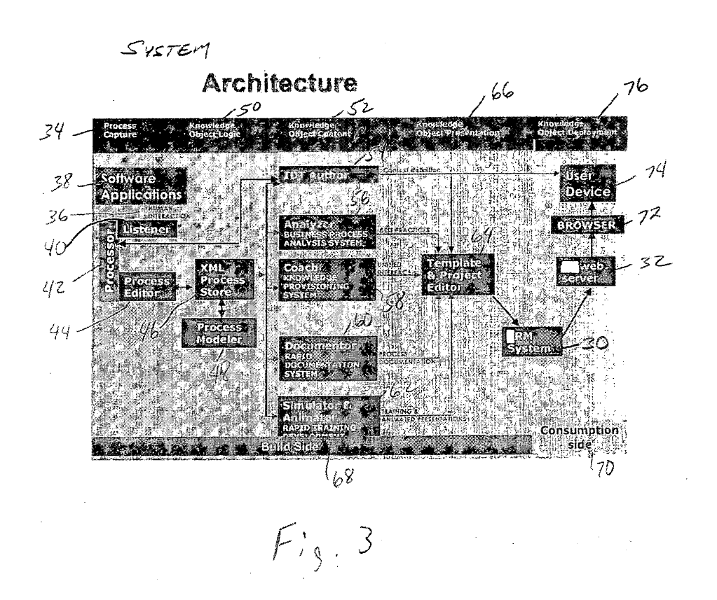

FIG. 3 shows an enterprise model to manage the knowledge objects across a business. The present system provides the capability to manage the knowledge objects and process files generated using the present system in a central repository using the repository management system (RM System) 30.

The repository management system 30 provides the capability to maintain versions of the knowledge objects and process the file in a central repository. The repository can be a web server 32 or a local server. The repository management system 30 also provides versioning capability. Further, the repository management system 30 provides a rich metatag definition and search capability. Additionally, the repository management system 30 provides a workflow management capability.

In further detail, FIG. 3 shows in the capture process 34 the capture of human interactions 36 with software applications 38. These interactions are monitored by a listener 40. The listener 40 works with the processor 42 and a process editor 44 to forward XML data to an XML process storage 46 in a knowledge object logic portion 50. The process is modeled by a process modeler 48. The process storage 46 communicates with elements of a knowledge object content layer 52, including an IDT author 54, an analyzer 56 for a business process analysis system, a coach 58 of a knowledge provisioning system, a documentor 60 of a rapid documentation system, and a stimulator and animator 62 of a rapid training development system. The IDT author 54 provides content definition to a template and project editor 64 of a knowledge object presentation system 66. The analyzer 56 provides the best practices information to the template and project editor 64, the coach 58 provides a unified interface to the template and project editor 64, the documentor 60 provides process documentation to the template and project editor 64, and the simulator and animator 62 provides training and animated presentations to the template and project editor 64. The template and project editor 64 forwards the data to the repository management system 30, completing the work on the build side 68 of the process.

The consumption side 70 of the process takes the stored data from the repository management system 30, provides it to a web server 32 which in turn supplies it to a browser 72 or the user's device (or computer) 74. This results in the knowledge object deployment 76.

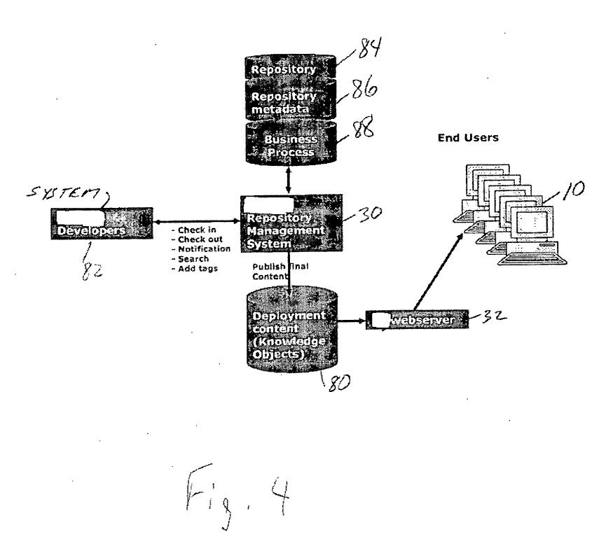

In FIG. 4, the final output of the RM system 30 is automatically published to the webserver system 32. The webserver system 32 is the server management system for all content and interfaces that are deployed and ready to be used by end users. End users 10 access the knowledge objects 80 based on their personal profile and needs.

The RM system 30 provides plug-ins to third party content and document management systems (such as Documentum, Interwoven and FileNet).

The webserver system 32 also provides plug-ins to some of the popular learning management systems.

Also shown in FIG. 4 is that system developers 82 may check in data, check out data, trigger notifications relating to the data, search the data and add tags to the stored data. The repository management system 30 manages the repository 84, repository metadata 86, and business processes 88.

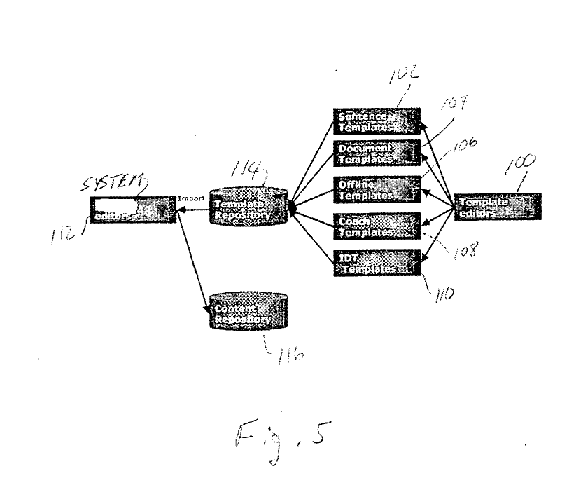

Referring to FIG. 5, a system for personalization and customization of knowledge objects using templates is shown. Template editors 100 provide the capability of customizing the look and feel of knowledge objects. More precisely, the template editors 100 provide sentence templates 102, document templates 104, offline templates 106, coach templates 108 and IDT templates 110. Developers, or system editors 112 can import or export templates onto a template repository 114. The template repository 114 contains XML tagged content information for all the knowledge objects components (sentences, documents, etc.). The system editors 112 also forward content to a content repository 116.

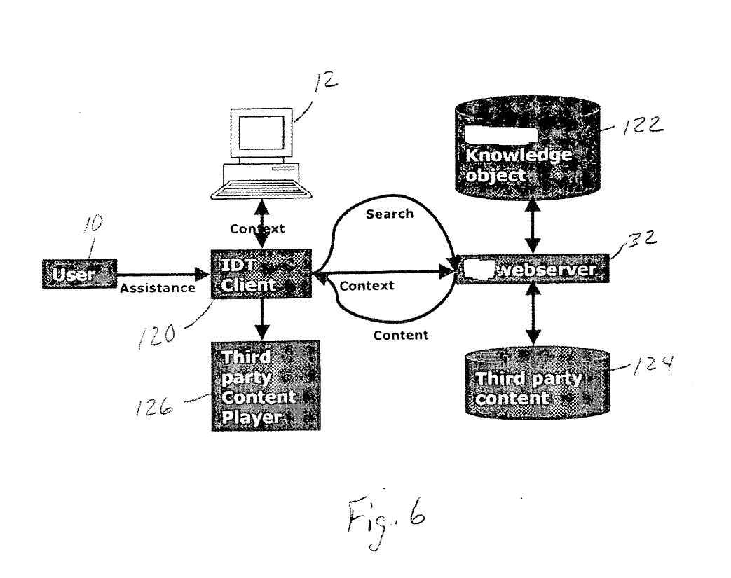

As shown in FIG. 6, the reuse of objects is possible for just-in-time knowledge provisioning systems. The knowledge objects developed can be reused to serve as a non-invasive knowledge management and performance support system. IDT (Intelligent Dialog Technology) is the technology foundation that will help conduct a dialog with the user 10 in order to obtain information from the user in order to achieve a stated process goal (such as completing an order taking process or completing a change in address).

The IDT is applicable to scenarios where: a) people use processes involving use of an application or browser or PDA/WML interfaces, and b) a process is well defined and the numbers of processes that will be subjected to an interactive dialog with user are finite. The IDT uses fuzzy logic techniques as well as regular rule engines to ascertain the goal, the process or resource required to be provided to further a dialog to a successful conclusion.

The task of the IDT client 120 is three fold:
Determine the context 12 of the user 10 or where the user is in the live application.
Conduct a dialog and find out what process the user 10 wants to complete.
Display the knowledge objects 122 as determined by the web server 32.

The web server 32 based on the two parameters determined above determines the knowledge objects 122 that are best suited for the user 10 (using a process discovery approach).

The FIG. 6 explains the interaction between IDT client 120 and the web server 32. The IDT client 120 can also play third party content 124 using a third party content player 126. A common API layer is provided for third party content 124 providers to incorporate into the system. Using this API, third party content 124 can be used as for e-learning as well as a performance support.

The present system is open and permits the addition of the third party content 124. Developers can add third party content 124 as a part of the IDT client 120. The IDT client 120 can therefore show third party content 124 based on the context 12 instead of knowledge objects 122. Third party content 124 can also be added to offline content. Third party content 124 can replace a specific part of offline content. The following is the list of components that can be replaced by any other third party component: offline documentation, an offline show me, an offline guide, an offline test, and a link to individual steps in coach

| | |
|---|---|
| Core | Provides the following functionality |
| technology | Capture |
| | Inspect |
| | Track |
| | Notify |
| | Playback |
| | The system processor product uses these functions to |
| | capture events and images. Third party programs can also |
| | request the services of these components |
| Programming | These provide functionality to use the capabilities of the |
| interface to | system products. For example programming developers |
| the system | can use the system processor, the documentor, |
| | the animator, or the analyzer functionality within their |
| | programming environment. |
| Interface to | These APIs provide access to the XML files. |
| the XML files | The XML files include the following: |
| | Capture XML file |
| | Knowledge Object XML file |

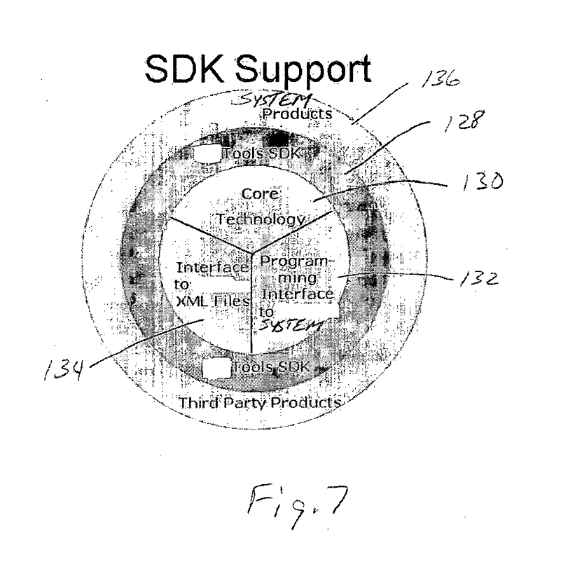

The present system and method provides custom products and solutions using sophisticated API support. The API support is provided through a tool kit 128 as shown in FIG. 7. The tool kit consists of:
core technology components 130 including capture, inspect, notify, track and playback,
programming interfaces 132 to the products using the present technology, and
interfaces 134 to access the present process and content XML files.

These are provided as computer products 136, and may be provided in conjunction with third party products 138.

Referring to FIG. 7, editors and products have been written using the present tools. Programming developers can embed the solutions into their product using a tools development kit. However, the developers need a tool runtime system to deploy their solution. The following table outlines the main components of the tools.

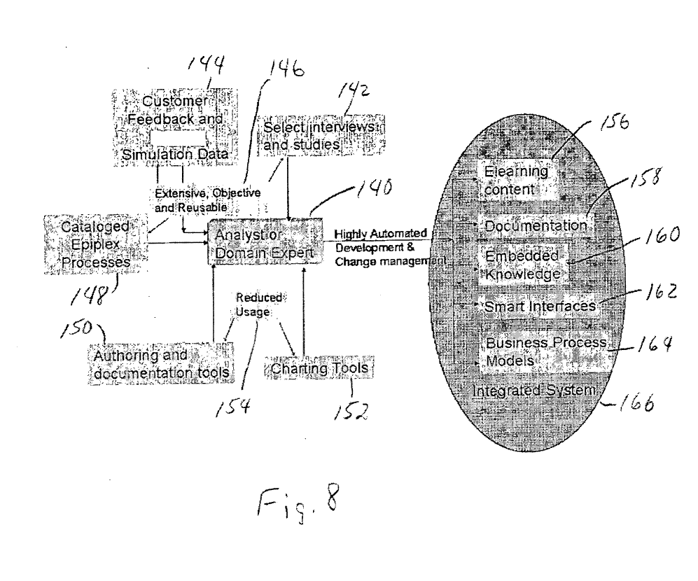

FIG. 8 provides an example of the use of the present system. The present system improves the way that documentation and e-learning content is generated. It provides automation, rapid and easy management, personalization and customization. The present system presents complex processes in a simplified manner, provides automation and makes applications context aware and goal aware with decision making knowledge and information. There is provided automatic generation of these features, rapid and easy change in management, personalization and customization. The present system also improves how current or new processes (as-is and to-be processes) are developed, including by semi-automatic generation, rapid and easy change management, personalization and customization.

In FIG. 8, an analyst or domain expert 140 receives information on selected interviews 142 as well as customer feedback and simulation data 144 through extensive objective and reusable processes 146. This is also fed to the cataloged processes 148 which are provided to the expert or analyst 140. The expert or analyst 140 uses authoring and documentation tools 150 and charting tools 152. A reduced usage 154 of these tools 150 and 152 is provided. With this information in hand, the expert or analyst 140 provides highly automated developmental and change management of the processes. This includes e-learning content 156, documentation 158, embedded knowledge 160, smart interfaces for the users 160, and business process models 164, all within an integrated system 166.

According to FIG. 8, the present system of one embodiment is completely automated. This eliminates costs, time and effort in development. An estimated 80 to 90 percent of the effort in development, change management, personalization, translation, customization. In one embodiment, over 90 percent of the task of process support is automated. Even business users can perform the process support task, so that it is now possible to provide widespread improvements in business process performance. Developers can develop sophisticated outcomes in a small fraction of the time.

The present system provides a highly automated and a non-programmatic approach to dynamically link information, e-mails, decision support information or knowledge. Most of the links and contexts are established automatically, making it possible for a highly flexible and powerful context and process aware knowledge provision. Also, the present method provides for managing changes or personalization in an extremely easy way. The present system has a mostly automatic “as is” model development. An efficient and accurate model development cycle is provided. A highly efficient means (with an audit trail) of securing user feedback and acting on them is available.

The present system in one embodiment auto generates the base models based on widespread captured processes, substituting over 80% of the tedium involved and averting most of the errors and omissions that occur at this stage. This makes it easy for an expert to use any charting tool to fine tune and apply the experts expertise in model development in the most efficient manner. Secondly, once a model is employed, the present system will constantly assess if the model is in use and help manage changes and ensure currency and compliance more efficiently.

As such, the present method and apparatus provides that a user of a computer performing a process is provided with automatic generation of objects to assist the user in the process being performed A user interface being used by the user is automatically identified. Process guides and aids for the user assisting the user are generated.

The present method and system provides guides and assistants to users of the computer with simplifies the user's work, guides the user through the processes to be performed by the user and trains the user so that the user performs the process as if the user were highly experienced and expert in the process. The guides, templates and training is context aware so that the user need not know when to active the guides, the present system actives the guides at the appropriate time. Knowledge is thereby provided, in the form of knowledge objects. The goals of the user and of the business or organization are realized more effectively and efficiently.

Although other modifications and changes may be suggested by those skilled in the art, it is the intention of the inventors to embody within the patent warranted hereon all changes and modifications as reasonably and properly come within the scope of their contribution to the art.

1. A method for object identification, comprising the steps of:
determining a context of a user's actions;
determining a goal of a user's actions;
based on the context and the goal, determining a path for the user to reach the goal; and
determining process aids and guidance for use by the user to aid in reaching the goal.

2. A method for knowledge object generation and deployment, comprising the steps of:
capturing user interactions with software applications;
modeling processes being performed by the user during the interactions;
generating knowledge content including:
defining a context of the interactions,
providing at least one of documentation and training relating to the process; and
deploying the knowledge content as knowledge objects to a user device.

3. A method as claimed in claim 2, wherein said generating knowledge content includes providing best practices for the process.

4. A method as claimed in claim 2, wherein said deploying is through a web server to a browser of a user device.

5. A method as claimed in claim 2, further comprising the step of:
depositing said knowledge objects in a repository prior to said step of deploying.

6. A method as claimed in claim 5, further comprising the step of:
providing access to said repository by a developer.

7. A method as claimed in claim 2, further comprising the step of:
incorporating third party content with said knowledge objects.

8. A method as claimed in claim 2, further comprising the steps of:
providing said knowledge objects as templates; and
editing said templates.

9. A method as claimed in claim 8, wherein said editing of said templates includes at least one of: sentence templates, document templates, offline templates, coach templates and internet data transfer templates.

10. A software developer's tool kit, comprising:
a tool kit for developers of software, including:
a core technology component;
a programming interface to a system; and
an interface to system process files.

11. A software developer's kit as claimed in claim 10, wherein said system process files are XML files.

12. A software developer's kit as claimed in claim 11, wherein said XML files include captured process files of a user performing a process.

13. A software developer's kit as claimed in claim 12, wherein said XML files further include edited process files of a to-be process.

14. A system for knowledge object generation, comprising:
process capture elements operable to capture user interaction with software applications as captured processes;
a storage connected to receive and store said captured process;
a knowledge content layer connected to receive said captured processes from said storage for analysis of content;
a presentation layer connected to receive said content of said knowledge content layer to present said content as templates; and
a deployment layer connected to receive said templates from said presentation layer and provide said templates to a user's device.

15. A system as claimed in claim 14, wherein said knowledge content layer includes at least one of the following:
an internet data transfer author to provide context definition;
an analyzer to provide process analysis,
a coach to provide knowledge provisioning as an interface,
a documentor to provide process documentation, and
a simulator to provide training presentations.

16. A system as claimed in claim 14, further comprising:
a repository connected to receive templates from said presentation layer and to provide said templates to said deployment layer.
